(19) United States
(12) Patent Application Publication
(10) Pub. No.: US 2026/0142279 A1
(43) Pub. Date: May 21, 2026

(54) ENERGY STORAGE SYSTEM INCLUDING NON-STRUCTURAL END PLATES

(71) Applicant: Fluence Energy, LLC, Arlington, VA (US)

(72) Inventors: Kathryn Corine Streng Callahan, Golden, CO (US); Jordan David Petrie, Neenah, WI (US); Elizabeth Anne Schroeder, Lake Orion, MI (US)

(73) Assignee: Fluence Energy, LLC, Arlington, VA (US)

(21) Appl. No.: 19/392,026

(22) Filed: Nov. 17, 2025

Related U.S. Application Data
(60) Provisional application No. 63/721,820, filed on Nov. 18, 2024.

(51) Int. Cl. H01M 10/658; H01M 10/613; H01M 50/224; H01M 50/242; H01M 50/258

(52) U.S. Cl. CPC H01M 10/658; H01M 50/224; H01M 50/242; H01M 50/258; H01M 10/613

(57) ABSTRACT

An energy storage enclosure includes a battery pack, a plurality of battery modules disposed within the battery pack. Each of the plurality of battery modules includes a battery module enclosure, a plurality of battery submodules disposed the battery module enclosure, a plurality of mid-beams disposed within the battery module enclosure, and a plurality of thermal isolation layers disposed within the battery module enclosure. Each of the plurality of battery submodules includes a pair of opposing end plates, and a plurality of battery cells disposed between the pair of opposing end plates. Each of the plurality of mid-beams is disposed between adjacent battery submodules. At least one of the plurality of thermal isolation layers is disposed adjacent to one of the plurality of mid-beams, and at least another of the plurality of thermal isolation layers is disposed adjacent to an internal surface of the battery module enclosure.

### CROSS-REFERENCE TO RELATED APPLICATIONS

This application claims the benefit of U.S. Provisional Application Number 63/721,820, filed on Nov. 18, 2024, which is hereby incorporated by reference in its entirety.

### INTRODUCTION

The concepts described herein relate generally to energy storage systems, and more specifically, to energy storage systems including battery modules with submodules that have structural interconnect boards (ICBs).

Energy storage systems include multiple individual energy storage enclosures interconnected to provide varied levels of storage capacity. Energy storage systems can be used to store additional power produced by an external power source during periods of reduced demand and provide additional power to external power sources during periods of increased demand.

Each individual energy storage enclosure includes battery packs that include multiple battery modules having a battery module enclosure containing multiple submodules. Each battery submodule includes multiple individual battery cells disposed adjacent to one another. ICB assemblies, which are disposed on opposing sides of each individual battery cell, provide sensing and bussing between adjacent battery cells.

For each battery module, the individual battery submodules are assembled prior to being disposed within the battery module enclosure. As the individual battery submodules are fragile, it would be advantageous to provide battery modules and battery submodules that are more robust.

### SUMMARY

In view of the above discussion, it is useful to develop an energy storage system including battery modules having battery module enclosures that provide structural support for the battery module and cell expansion support, and battery submodules having end-plates that provide lift points for use during manufacturing and assembly.

The concepts disclosed herein relate to an energy storage enclosure that may include a battery pack, and a plurality of battery modules disposed within the battery pack. Each of the plurality of battery modules may include a battery module enclosure, and a plurality of battery submodules disposed within the battery module enclosure. Each of the plurality of battery submodules may include a pair of opposing end plates, and a plurality of battery cells disposed between the pair of opposing end plates.

A plurality of mid-beams may be disposed within the battery module enclosure. Each of the plurality of mid-beams may be disposed between adjacent battery submodules.

A plurality of thermal isolation layers may be disposed within the battery module enclosure, and at least one of the plurality of thermal isolation layers may be disposed adjacent to one of the one of the plurality of mid-beams.

According to one aspect of the disclosure, at least another of the plurality of thermal isolation layers may be adjacent to an inside surface of the battery module enclosure. Each of the plurality of thermal isolation layers may include a compressible material.

The battery module enclosure may include a bottom plate, a front wall, a rear wall, and a pair of side walls. The bottom plate, the front wall, the rear wall, and the pair of side walls of the battery module enclosure may be formed from as a single piece, and may be extruded aluminum.

At least another of the plurality of thermal isolation layers may be adjacent to at least one of the pair of side walls.

According to one aspect of the disclosure, each of the pair of opposing end plates may include at least one opening, which may be configured for lifting and/or fixturing of the battery submodule.

According to another aspect of the disclosure, an energy storage system may include at least two energy storage enclosures coupled to one another. Each of the at least two energy storage enclosures may include a battery pack, and a plurality of battery modules disposed within the battery pack.

Each of the plurality of battery modules may include a battery module enclosure, and a plurality of battery submodules disposed within the battery module enclosure.

Each of the plurality of battery submodules may include a pair of opposing end plates, and a plurality of battery cells disposed between the pair of opposing end plates.

A plurality of mid-beams may be disposed within the battery module enclosure. Each of the plurality of mid-beams may be disposed between adjacent battery submodules.

A plurality of thermal isolation layers may be disposed within the battery module enclosure. At least one of the plurality of thermal isolation layers may be disposed adjacent to one of the plurality of mid-beams, and at least another of the plurality of thermal isolation layers may be disposed adjacent to an internal surface of the battery module enclosure.

An energy storage system including at least two energy storage enclosures discussed above coupled to one another, and an energy storage system including at least two energy storage enclosures or “pods” electrically coupled to one another and to a smartskid is also disclosed.

By providing battery submodules arranged within an energy enclosure and/or a pod, each battery submodule having a pair of opposing end plates that include openings, the manufacturing and handling processes of the battery submodules during assembly of the battery modules may be streamlined.

Further, by providing a battery module having a one-piece battery enclosure, for example but not limited to a one-piece aluminum extruded battery enclosure, structural support for the battery module, as well as support for battery cell expansion may be increased.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 schematically illustrates an energy storage system including a plurality of energy storage enclosures, in accordance with the disclosure.

FIG. 2 is a schematic isometric view of another energy storage system, in accordance with one aspect of the disclosure.

FIG. 3 is a schematic front view of the energy storage system, in accordance with one aspect of the disclosure.

FIG. 4 is a schematic isometric view of yet another energy storage system, in accordance with one aspect of the disclosure.

FIG. 5 schematically illustrates an energy storage enclosure or “pod,” in accordance with one aspect of the disclosure.

FIG. 6 schematically illustrates an exploded view of a battery module, in accordance with one aspect of the disclosure.

FIG. 7 schematically illustrates a cross-sectional top view of battery module, in accordance with one aspect of the disclosure.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present disclosure is susceptible of embodiment in many different forms. Representative examples of the disclosure are shown in the drawings and described herein in detail as non-limiting examples of the disclosed principles. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as “vertical”, “horizontal”, “left”, “right”, “upper”, “lower”, “top”, “bottom” and similar expressions are non-limiting terms that merely describe the various elements as illustrated in the Figures and are not intended to limit the scope of the disclosure.

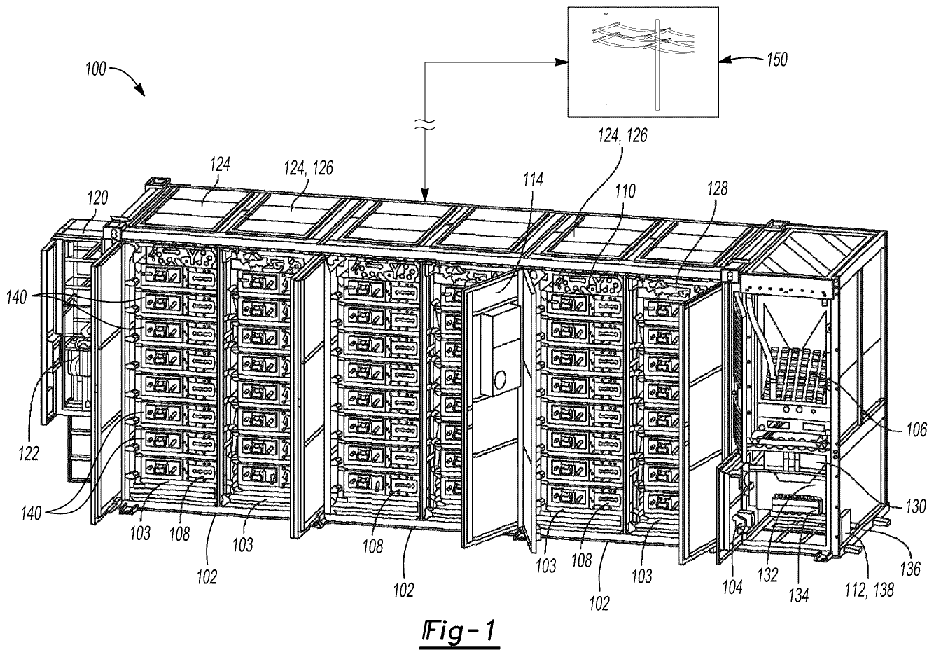

Referring to the drawings, wherein like reference numbers refer to the same or like components in the several Figures. FIG. 1 schematically illustrates an isometric view of an energy storage system 100, according to one embodiment of the present disclosure. The energy storage system 100 includes a plurality of energy storage enclosures 102, a controller 104, a cooling system (or chiller) 106 (which may be external or internal within the energy storage enclosure 102 as would be known by one of ordinary skill in the art), multiple power conversion modules 108, multiple direct current protection modules (DCPM) 110, auxiliary components 112, a heating, ventilation, and air conditioning (HVAC) system 114, a fire panel 116, and plumbing 118.

The energy storage system 100 may also include a DC disconnector box 120, a DC disconnect switch 122, multiple deflagration panels 124, multiple passive vents 126, a DC-DC converter 128, an uninterruptible power supply (UPS) 130, a master control board (MCB) 132, a power distributor 134, a grounding point 136, an enclosure to enclosure connections 138 and multiple battery modules 140.

In various embodiments, the energy storage system 100 implements a battery energy storage system (BESS). In some embodiments, the energy storage system 100 may include one or more of a battery cell, a battery module, a battery pack, a battery enclosure, a battery node, and/or a battery core.

The plurality of energy storage enclosures 102 may be coupled to one another electrically. The plurality of energy storage enclosures 102, individually and collectively, may operate to store alternating current (AC) power delivered from an external power source 150 as direct current (DC) energy, for example but not limited to when the demand for power from the external power source 150 is lower than the external power source 150 is operable to generate, and/or to provide AC power to the external power source 150, for example, when the demand for power is higher than the external power source 150 may generate to provide the additional power. It should be appreciated that the plurality of energy storage enclosures 102 may be coupled to one another not only electrically, but also mechanically, and/or fluidly.

To facilitate the conversion of AC power to DC power and DC power to AC power, the power conversion module 108 may be used to standardize power input and output between the plurality of energy storage enclosures 102 and the external power source 150. The power conversion module 108 may include a converter to convert AC power to DC power, and/or DC power to AC power.

The cooling system 106 may be coupled to the plurality of energy storage enclosures 102 and the controller 104. The external cooling system may provide coolant at a first temperature T₁ to the plurality of energy storage enclosures 102 through at least one input port 160 and receive coolant from the plurality of energy storage units at a second temperature T₂ from at least output port 170, such that T₁ is lower than T₂.

The cooling system 106 may include, for example, a heat exchanging system having a pump, a condenser, a heat exchange, and a sump. It should be appreciated that the at least one input port 160 and the at least one output port 170 may include more than one input port and/or one output port, and each of which may be disposed in one or more of the multiple energy storage enclosures 102.

The external power source 150 may be coupled to the plurality of energy storage enclosures 102. The external power source 150 may be operable to provide AC power converted to DC power to the plurality of energy storage enclosures 102 to be stored as DC energy, and to receive AC power converted from DC power from the plurality of energy storage enclosures 102, as discussed above.

The controller 104 may be in communication with the plurality of energy storage enclosures 102, the power conversion module 108, the cooling system 106, and the external power source 150, and may be used to control the aforementioned plurality of energy storage enclosures 102, the power conversion module 108, the cooling system 106, and their communication with the external power source 150.

The term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated memory component(s) in the form of transitory and/or non-transitory computer readable storage medium (or memory) component(s) and storage devices (read only, programmable read only, random access, hard drive, etc.). The non-transitory computer readable storage medium/memory component may be capable of storing machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital inverters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables.

The energy storage enclosures 102 may each include one or more battery packs 103, and a plurality of battery modules 140 disposed within each battery pack 103, according to an embodiment of the present disclosure. Further, each battery module 140 may also contain multiple battery submodules that may house individual battery cells (not shown).

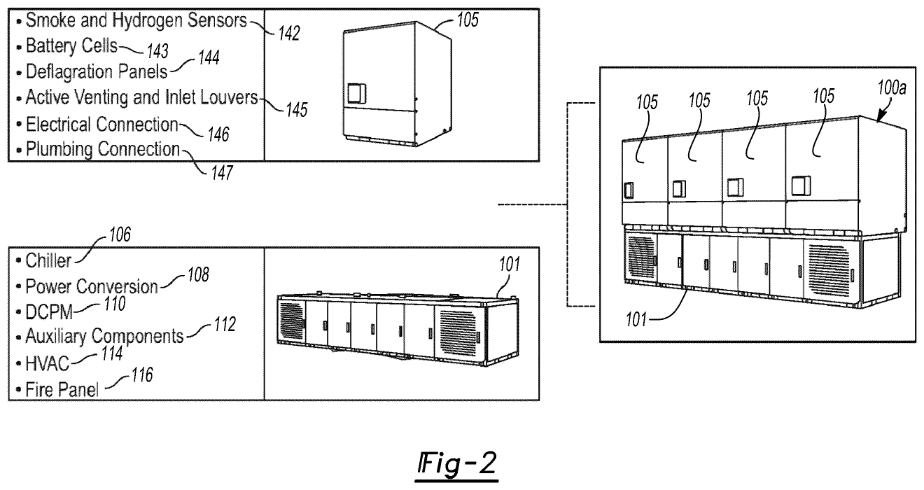

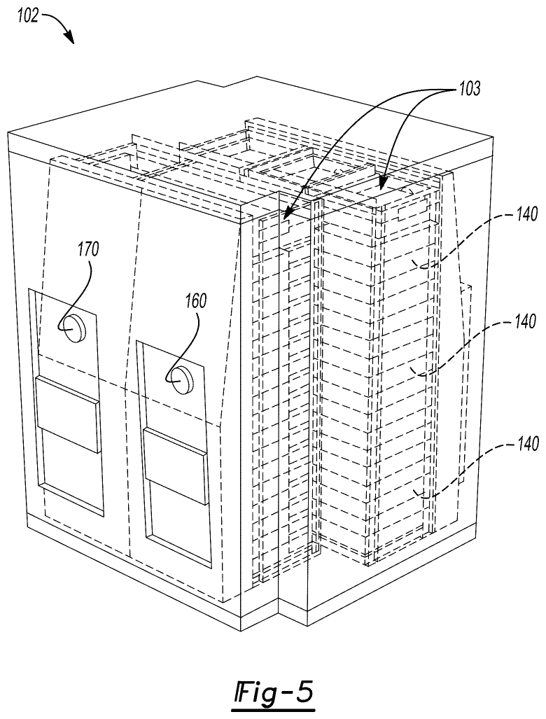

Referring to FIG. 2, a schematic isometric view of another energy storage system 100a is shown in accordance with one aspect of the disclosure. The energy storage system 100a generally includes a smartskid 101 and multiple (e.g., four (4)) pods 105 coupled to the smartskid 101. Each pod 105 includes at least one battery pack 103 having a plurality of battery modules 140 arranged in a stacked arrangement (FIG. 5). The smartskid 101 includes a cooling system 106, a power conversion module 108, a DCPM 110, auxiliary components 112, an HVAC 114, and a fire panel 116. Each pod 105 includes smoke and hydrogen sensor 142, battery cells 143, deflagration panels 144, active venting and inlet louvers 145, electrical connections 146, and plumbing connections 147.

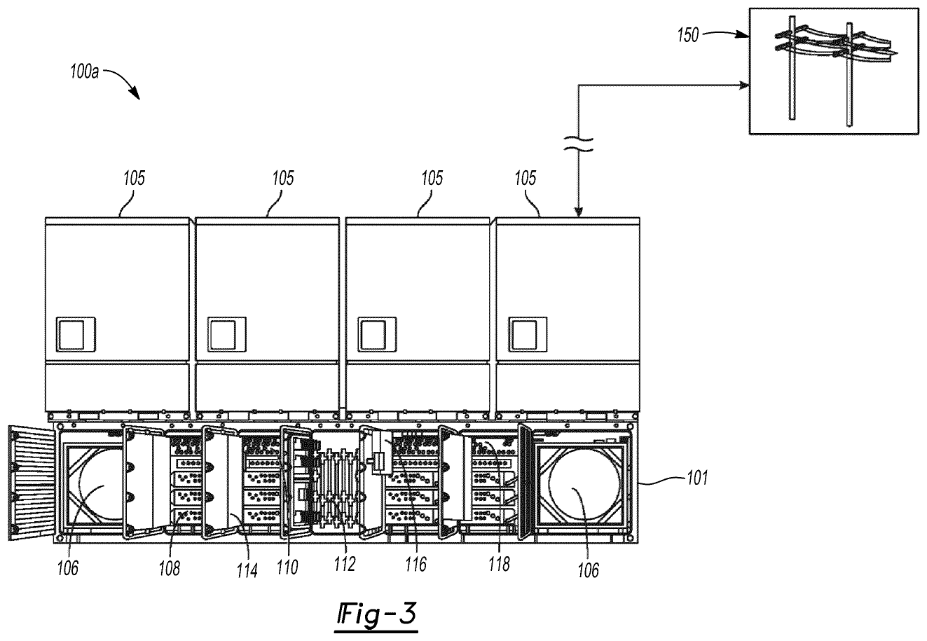

Referring to FIG. 3, a schematic front view of the energy storage system 100a is shown in accordance with one aspect of the disclosure. The smartskid 101 generally includes two cooling systems 106, the power conversion module 108, the DCPM 110, the auxiliary components 112, the HVAC 114, the fire panel 116, and plumbing 118. The energy storage system 100a (and 100 shown in FIG. 1) may be coupled with the external power source 150.

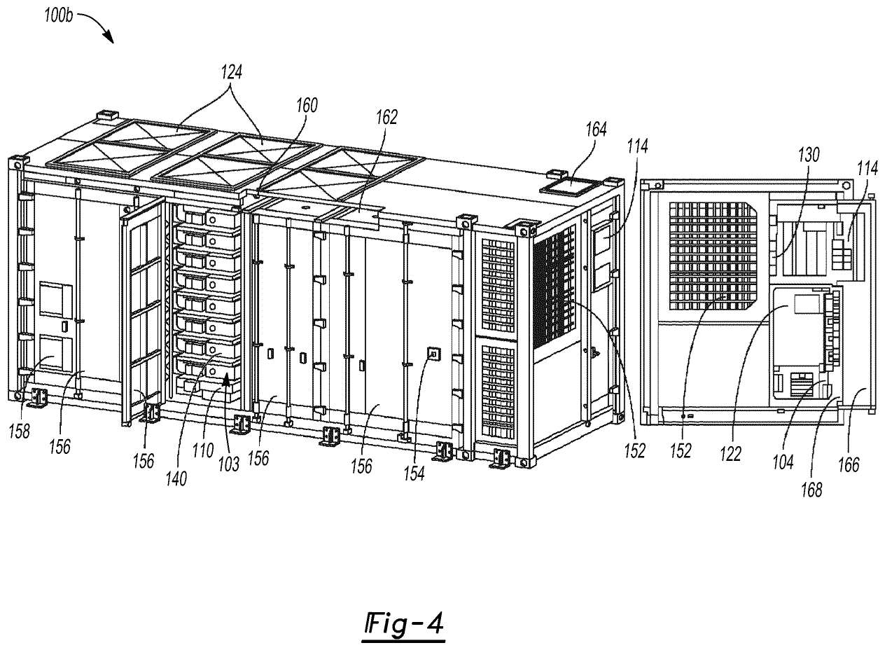

Referring to FIG. 4, a schematic isometric view of yet another energy storage system 100b is shown in accordance with one aspect of the disclosure. The energy storage system 100b generally includes the controller 104, the DCPM 110, the HVAC 114, the DC disconnect switch 122, the deflagration panels 124, the UPS 130, the battery modules 140, a chiller compartment 152, a fast stop (F-stop) 154, an enclosure door 156, an inlet louver 158, multi detectors 160, a hydrogen (H₂) gas detector 162, a vent panel 164, an enclosure side door 166, and a battery cooling plate (BCP) door 168.

As schematically illustrated in FIG. 5, each of the plurality of energy storage enclosures 102 or pods 105 includes battery packs 103, and pluralities of battery modules 140 disposed in a stacked arrangement within each battery pack 103.

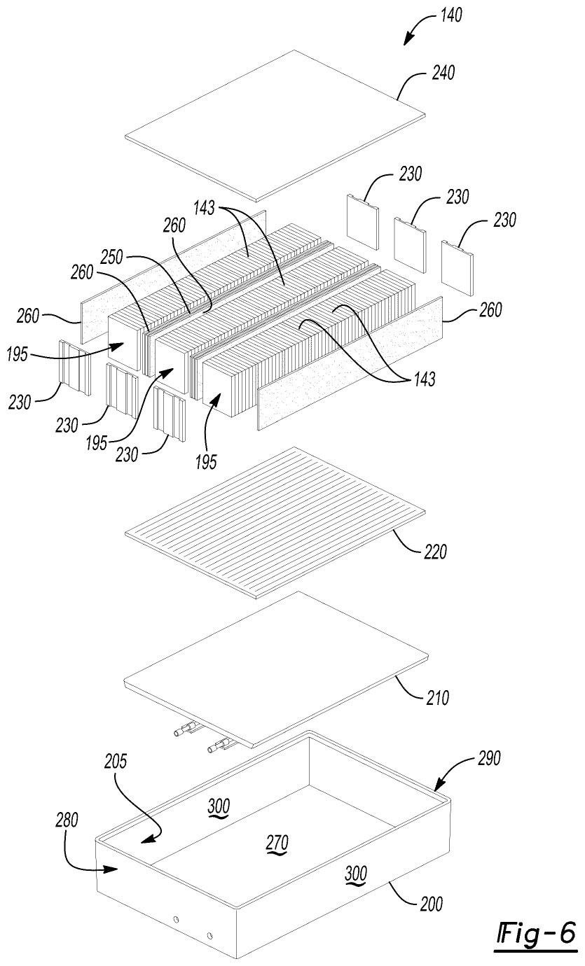

An exploded view of one of the plurality of battery modules 140 is schematically illustrated in FIG. 6. The battery module 140 includes a battery module enclosure 200, a plurality of battery submodules 195, a cooling plate 210, a battery module thermal interface layer 220, a plurality of pairs of opposing end plates 230, a plurality of battery cells 143, and a top plate 240.

The plurality of battery submodules 195 are disposed within the battery module enclosure 200. Each of the plurality of battery submodules 195 includes a pair of opposing end plates 230, a plurality of mid-beams 250, and a plurality of thermal insulation layers 260. Each pair of opposing end plates are arranged at opposing ends of each of the plurality of battery submodules 195, and a plurality of battery cells 143 disposed within the pair of opposing end plates 230.

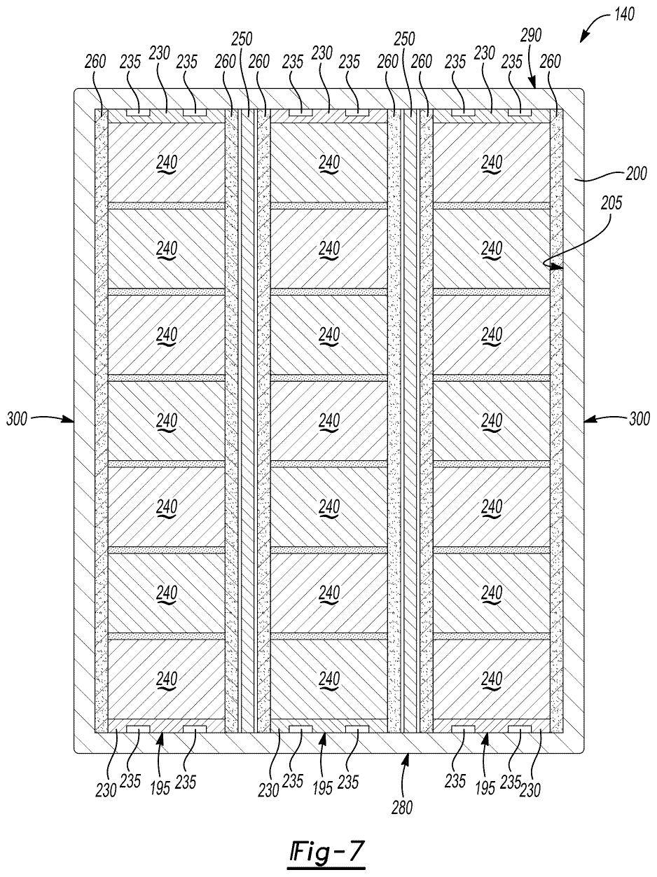

As schematically illustrated in FIG. 7, each of the plurality of mid-beams 250 is disposed between adjacent battery submodules of the plurality of submodules 195, and at least one of the plurality of thermal isolation layers 260 is disposed adjacent to at least one of the plurality of mid-beams 250.

At least another of the plurality of thermal isolation layers 260 is disposed adjacent to an inside surface 205 of the battery module enclosure 200.

Each of the plurality of thermal isolation layers 260 includes a compressible material.

The battery module enclosure 200 includes a bottom plate 270, a front wall 280, a rear wall 290, and a pair of side walls 300.

According to one aspect of the disclosure, the bottom plate 270, the front wall 280, the rear wall 290, and the pair of side walls 300 of the battery module enclosure 200 are formed as a single piece of, for example but not limited to, an extruded aluminum.

At least another of the plurality of thermal isolation layers 260 is adjacent to at least one of the pair of side walls 300.

According to one aspect of the disclosure, each of the pair of opposing end plates 230 are non-structural and include at least one opening 235 configured for lifting and/or fixturing of the battery submodule 195, to facilitate manufacturing and handling of the battery submodules 195 and/or the battery modules 140 by, for example but not limited to, providing slots or openings for insertion of fork lift forks.

An energy storage system 100 is also disclosed. The modular energy system 100 includes: at least two energy storage enclosures 102 coupled to one another.

Each of the at least two energy storage enclosures 102 includes: a battery pack 180, and a plurality of battery modules 140 disposed within the battery pack 180.

Each of the plurality of battery modules 140 includes: a battery module enclosure 200, and a plurality of battery submodules 195 disposed within the battery module enclosure 200.

Each of the plurality of battery submodules 195 includes: a pair of opposing end plates 230, and a plurality of battery cells 143 disposed between the pair of opposing end plates.

A plurality of mid-beams 250, and a plurality of thermal isolation layers 260 are disposed within the battery module enclosure 200. Each of the plurality of mid-beams 250 is disposed between adjacent battery submodules 195, and at least one of the plurality of thermal isolation layers 260 is disposed adjacent to one of the plurality of mid-beams 250.

At least another of the plurality of thermal isolation layers 260 is disposed adjacent to an internal surface 205 of the battery module enclosure 200.

As such, by providing battery submodules, each having a pair of opposing end plates that include openings, the manufacturing and handling processes of the battery submodules during assembly of the battery modules may be improved and/or streamlined.

Further, by providing a battery module having a one-piece battery enclosure, for example but not limited to a one-piece aluminum extruded battery enclosure, structural support for the battery module, as well as support for battery cell expansion may be increased.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other examples for carrying out the present teachings have been described in detail, various alternative designs and aspects of the disclosure exist for practicing the present teachings defined in the appended claims.

What is claimed is:

1. An energy storage enclosure comprising:
a battery pack;
a plurality of battery modules disposed within the battery pack, wherein each of the plurality of battery modules includes:
a battery module enclosure;
a plurality of battery submodules disposed the battery module enclosure, wherein each of the plurality of battery submodules includes:
a pair of opposing end plates; and
a plurality of battery cells disposed between the pair of opposing end plates; and
a plurality of mid-beams disposed within the battery module enclosure, wherein each of the plurality of mid-beams is disposed between adjacent battery submodules; and
a plurality of thermal isolation layers disposed within the battery module enclosure, wherein at least one of the plurality of thermal isolation layers is disposed adjacent to at least one of the plurality of mid-beams.

2. The energy storage enclosure as recited in claim 1, wherein at least another of the plurality of thermal isolation layers is disposed adjacent to an inside surface of the battery module enclosure.

3. The energy storage enclosure as recited in claim 1, wherein each of the plurality of thermal isolation layers includes a compressible material.

4. The energy storage enclosure as recited in claim 1, wherein the battery module enclosure includes a bottom plate, a front wall, a rear wall, and a pair of side walls.

5. The energy storage enclosure as recited in claim 4, wherein the bottom plate, the front wall, the rear wall, and the pair of side walls of the battery module enclosure are formed from as a single piece.

6. The energy storage enclosure as recited in claim 5, wherein the battery module enclosure is extruded aluminum.

7. The energy storage enclosure as recited in claim 4, wherein at least another of the plurality of thermal isolation layers is adjacent to at least one of the pair of side walls.

8. The energy storage enclosure as recited in claim 1, wherein each of the pair of opposing end plates includes at least one opening.

9. The energy storage enclosure as recited in claim 8, wherein the at least one opening of each of the pair of opposing end plates is configured for lifting and/or fixturing of the battery submodule.

10. An energy storage system comprising:
at least two energy storage enclosures coupled to one another, wherein each of the at least two energy storage enclosures includes:
a battery pack;
a plurality of battery modules disposed within the battery pack, wherein each of the plurality of battery modules includes:
a battery module enclosure;
a plurality of battery submodules disposed the battery module enclosure, wherein each of the plurality of battery submodules includes:
a pair of opposing end plates; and
a plurality of battery cells disposed between the pair of opposing end plates; and
a plurality of mid-beams disposed within the battery module enclosure, wherein each of the plurality of mid-beams is disposed between adjacent battery submodules; and
a plurality of thermal isolation layers disposed within the battery module enclosure, wherein at least one of the plurality of thermal isolation layers is disposed adjacent to one of the plurality of mid-beams.

11. The energy storage system as recited in claim 10, wherein at least another of the plurality of thermal isolation layers is disposed adjacent to an inside surface of the battery module enclosure.

12. The energy storage system as recited in claim 10, wherein each of the plurality of thermal isolation layers includes a compressible material.

13. The energy storage system as recited in claim 10, wherein the battery module enclosure includes a bottom plate, a front wall, a rear wall, and a pair of side walls.

14. The energy storage system as recited in claim 13, wherein the bottom plate, the front wall, the rear wall, and the pair of side walls of the battery module enclosure are formed from as a single piece.

15. The energy storage system as recited in claim 14, wherein the battery module enclosure is extruded aluminum.

16. The energy storage system as recited in claim 15, wherein at least another of the plurality of thermal isolation layers is adjacent to at least one of the pair of side walls.

17. The energy storage system as recited in claim 10, wherein each of the pair of opposing end plates includes at least one opening.

18. The energy storage system as recited in claim 17, wherein the at least one opening of each of the pair of opposing end plates is configured for lifting and/or fixturing of the battery submodule.

19. An energy storage system comprising:
a smartskid including:
a cooling system; and
a power conversion module; and
a pod electrically coupled to the smartskid, wherein the pod includes:
a battery pack;
a plurality of battery modules disposed within the battery pack, wherein each of the plurality of battery modules includes:
a battery module enclosure;
a plurality of battery submodules disposed the battery module enclosure, wherein each of the plurality of battery submodules includes:
a pair of opposing end plates; and
a plurality of battery cells disposed between the pair of opposing end plates; and
a plurality of mid-beams disposed within the battery module enclosure, wherein each of the plurality of mid-beams is disposed between adjacent battery submodules; and
a plurality of thermal isolation layers disposed within the battery module enclosure, wherein at least one of the plurality of thermal isolation layers is disposed adjacent to one of the plurality of mid-beams.

20. The energy storage system as recited in claim 19, wherein the battery module enclosure includes a bottom plate, a front wall, a rear wall, and a pair of side walls.
